(19) United States
(12) Patent Application Publication
(10) Pub. No.: US 2015/0335500 A1
(43) Pub. Date: Nov. 26, 2015

(54) MODULAR RIGID FRAME WHEELCHAIR

(71) Applicants: GENE RAY WALTERS, (US); ERIN CARL WALTERS, (US)

(72) Inventors: GENE RAY WALTERS, (US); ERIN CARL WALTERS, (US)

(21) Appl. No.: 14/285,662

(22) Filed: May 23, 2014

(51) Int. Cl. A61G 5/08; A61G 5/12

(52) U.S. Cl. CPC A61G 5/08; A61G 5/12; A61G 2005/0875; A61G 2005/122; A61G 2005/128

(57) ABSTRACT

A modular rigid wheelchair comprised of a light weight rigid seat body module, which includes folding front wheel and castor assemblies, a detachable foot rest module which drops into receiver areas in the seat body framework, and a detachable contoured backrest module with fixed smooth curved thoracic upper backrest support, and lower separately adjustable lumbar support. Facilitating much lighter weight to be lifted into and out of a vehicle for transport, and a compact size for transport when folded.

### REFERENCES CITED

### U.S. Patent Doccuments

U.S. Pat. No. 8,632,129 B2 Huttenhuis
U.S. Pat. No. 8,573,622 B2 Papi
U.S. Pat. No. 8,641,078 B2 YANG

### BACKGROUND OF THE INVENTION

(1) Field of the Invention

Classification 250.1 subclass 242.1 vehicles for use by seated disabled occupant.

(2) Background Art

### BRIEF SUMMERY OF THE INVENTION

The primary objective of the invention is to provide a rigid wheelchair comprised of several light weight detachable modules that provide drop in assembly and disassembly. Thereby enabling people with limited mobility to load their wheelchair by lifting several light weight pieces instead of a heavy folded or non foldable rigid chair for transport with out assistance. The secondary objective is to at the same provide greater comfort and back support while seated in the chair, accomplished by means of the detachable adjustable backrest and separately adjustable lumbar support.

### BRIEF DESCRIPTION OF THE SEVERAL VIEWS OF THE DRAWINGS

FIG. 1 is an exploded view of a wheelchair embodiment of the present invention showing the seat assembly, folding caster wheel leg, detachable footrest, and detachable adjustable backrest FIG. 1a is a front perspective view of a wheelchair embodiment of the present invention showing the seat assembly.

FIG. 2 is a flat view of the adjustable curve lumbar support, and backrest.

### DETAILED DESCRIPTION EMBODIMENT OF THE INVENTION

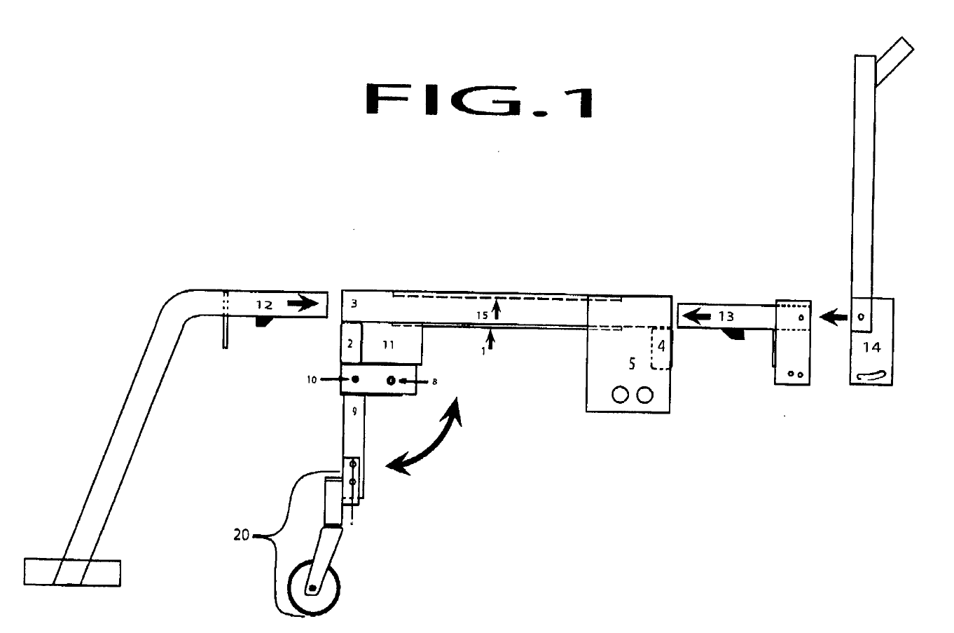

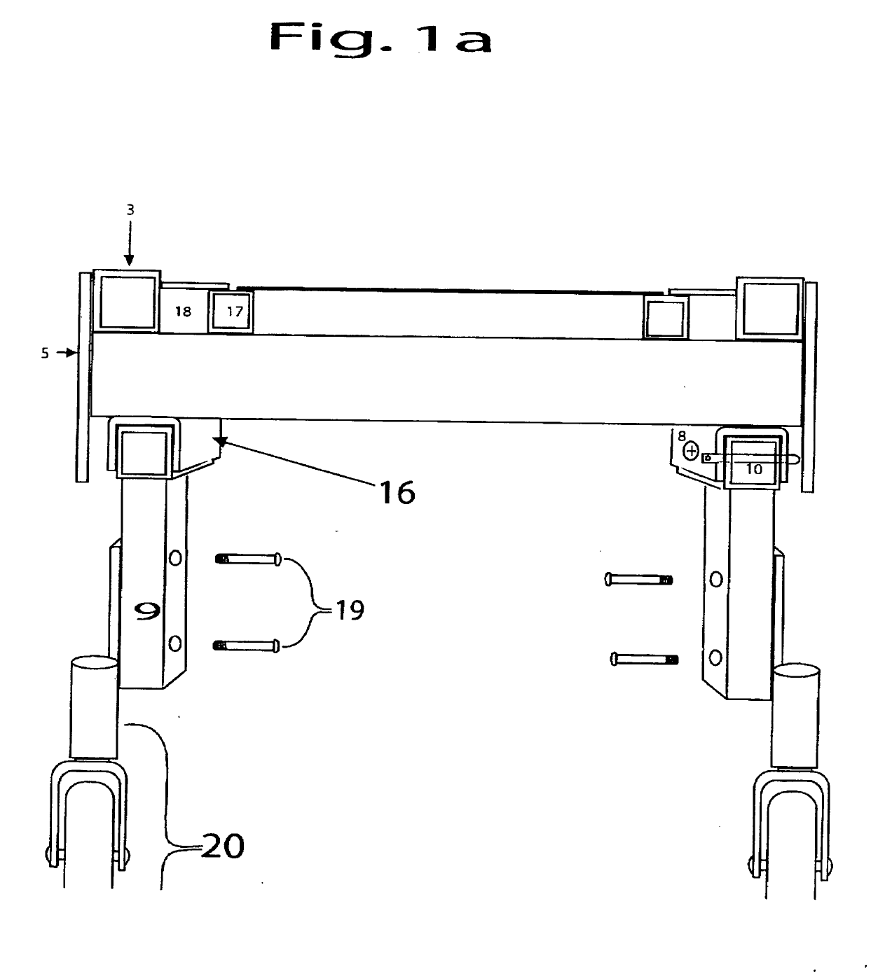

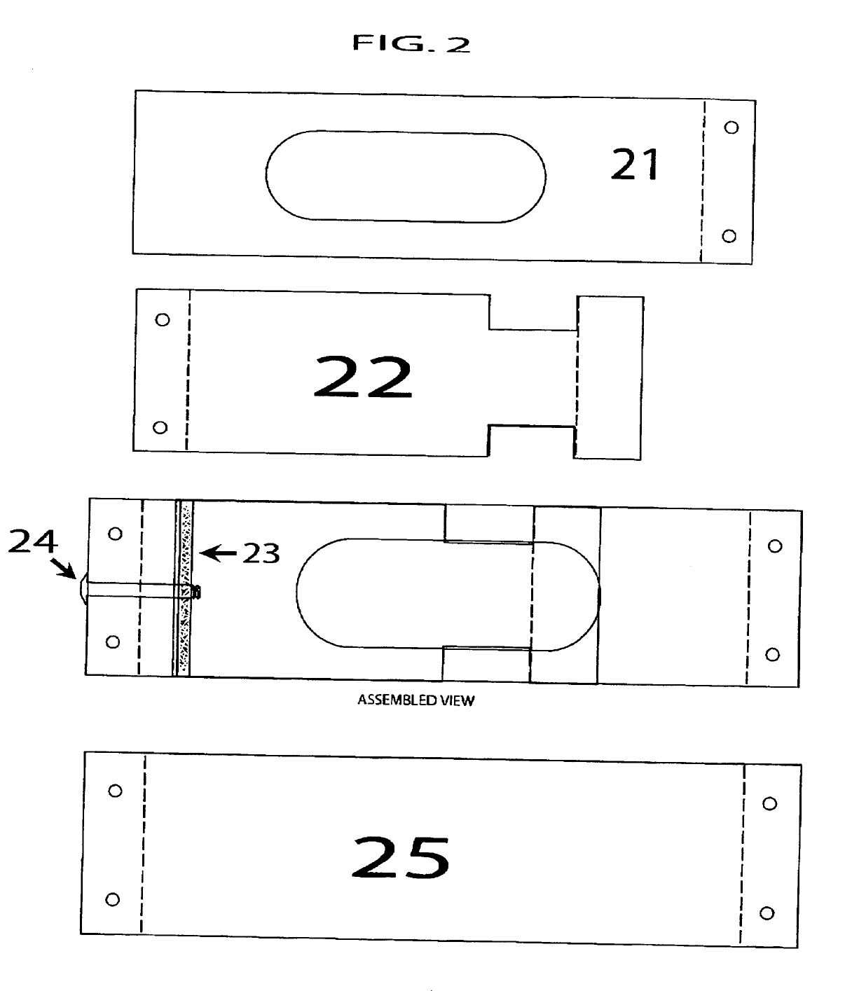

FIG. 1 shows a wheel chair seat and frame assembly comprised of welded tubular structure, transverse tubes 2, 4 and 17 being attached by welding to main frame tubes 3, as well as angularly mounted channels 16, wheel mount plates 5, and receiver forming plates 1 and 15, as well as brake mounting angles 11, upper and lower receiver former plates 1 lower, and 15 upper, attach to inner receiver forming tubes 17, and outer tubes 3 to form front and rear receiver areas 18 shown on FIG. 1a. Wheel mount plate 5, are welded to main frame tube 3, and to rear tube 4 providing adjustable C.G. for (rear wheels not shown). Angularly retractable front caster and wheel mounting legs 9 are positioned in channels 16 shown in FIG. 1a. Channels 16 are angularly mounted, this means they are mounted angling toward the center of the rear of the seat body, this allows the caster wheels 20 to lay flat when retracted and lay against the bottom of the rear of the seat area without protruding past the perimeter of the seat body for transport. Caster wheels 20 when folded inside the seat and frame assembly allow the assembled seat body module to stand up while the rear wheels (not shown) are installed for use, or when being removed for transport by the user. Pivot bolt 8 located at the rear of channel 16 allows the caster and wheel mounting legs 9 and caster wheel 20 to swing back while the wheels 20 rotate on the caster and lay flat toward the center of the seat when retracted. Pivot bolt 8 being at the rear also allows the caster and wheel mounting legs 9 and caster wheels 20 to use the force of gravity to hold the caster and wheel mounting legs 9 and channel 16 in perfect alignment when in the swung forward position while pin 10 is inserted into channel 16 and caster and wheel mounting legs 9 for use. The angular folding of the caster and wheel mounting legs 9 and the rotation of caster wheels 20 to a flat position between the wheel mount plates 5, parallel with the transverse tube 4 causes the seat body module assembly to be extremely compact when folded, thus requiring much less effort and strength for the user to lift the folded seat body assembly into the users vehicle for transport. Detent pin 10 locks the caster and wheel mounting legs 9 and caster wheels 20 in the upright position for use. Caster assembly mounting bolts 19 attach the caster assemblies to caster and wheel mounting legs 9. The 1 piece foot rest module 12 inserts into receiver area 18 FIG. 1a. The foot rest 12 drops into the receiver area 18 for use with little effort, only the very tips of the footrest 12 are inserted and trapped under the receiver forming plates 1 and 15. The latching effect is provided by the shape of the footrest assembly holding itself in position when dropped in place, The footrest can only be removed by lifting it upward and out of the receiver area. In an alternative embodiment (not shown) a mechanical pin device such as an L handle spring pin or removable pin device could be used to prevent the footrest assembly from being lifted out of the receiver area 18. The back rest lower attaching frame and hinge assembly 13 also inserts into receiver area 18 FIG. 1a on the opposite side of the seat body, it inserts and latches exactly in the same manner as the footrest 12, described above. It simply drops into place and latches to the seat and frame assembly by inserting the tips of the fully assembled backrest module assembly into receiver area 18, between receiver forming plates 1 and 15, and allowing it to drop down in to place. The latching effect is provided by the shape of the back rest lower attaching frame and hinge assembly 13, and the seat base. Very little effort is required for the user to drop the foot rest and back rest assemblies into place for use. This is an improvement over tube inside tube receiver designs, because no complex alignment of tubes or alignment of holes for fasteners are required for assembly. The backrest frame assembly 14 attaches to 13 with bolts (not shown) that attach, and allow the backrest to pivot and lock in place at the desired angle. 21, 22, and 25, frame assembly 14 and angle adjustment assembly 13 together form the backrest module to which both the upper fixed contour polycarbonate backrest 25, and the adjustable contour lumbar support 21, and 22 that are shown in FIG. 2 are attached with screws(not shown) The lumbar support is comprised of the adjustable tension strap 21, and the fixed tension strap 22, adjusting screw 24, and pull bar 23. Adjusting screw 24 pulls the pull bar 23 to increase or decrease curvature of the lumbar support. The adjustable tension strap 21, and fixed tension strap 22 are interlaced for a smooth continuous rigid lumbar support curve through the adjustment range. This is a major improvement in support and comfort over typical adjustable fabric straps or sling designs. Straps 21, 22, and 25 are made of rigid but still flexible polycarbonate plastic material which when screwed to the backrest frame 14 shown in FIG. 1 this material, forms a rigid smooth curve that can retain their shapes. This gives the user a much greater level of comfort and support than could be achieved using any arrangement of fabric straps or slings that do not have any ability to retain their shape. It also allows the user to change the shape of the lumbar support while remaining seated in the wheel chair.

What is claimed:

1. A modular wheelchair that is comprised of a rigid seat body capable of accepting a latching detachable footrest and a latching detachable adjustable backrest.

2. The chair of claim 1 incorporates angularly folding front caster wheel supporting legs that fold the front caster wheels flat into the seat body for transport.

3. The chair of claim 1 incorporates a contour and comfort adjustable backrest, rear receiver area to accept and latch ably attach the removable angle adjustable backrest and separately adjustable lumbar support.

4. The chair of claim 1 incorporates a detachable footrest, front receiver area to accept and latch ably attach the removable foot rest assembly.
